(19) United States
(12) Patent Application Publication
(10) Pub. No.: US 2019/0053465 A1
(43) Pub. Date: Feb. 21, 2019

(54) SYSTEMS AND METHODS FOR ATTACHING IDENTIFICATION INFORMATION TO AN ANIMAL

(71) Applicant: Somark Innovations Group Pty Ltd, Sydney, NSW (AU)

(72) Inventors: Adrian KNIGHT, Sydney, NSW (AU); Paul DONOHOE, Sydney, NSW (AU)

(21) Appl. No.: 16/077,730

(22) PCT Filed: Feb. 11, 2017
(86) PCT No.: PCT/AU2017/050119

§ 371 Date: Aug. 13, 2018

Related U.S. Application Data
(60) Provisional application No. 62/294,084, filed on Feb. 11, 2016.

(30) Foreign Application Priority Data
Oct. 31, 2016 (AU) 2016904434

(51) Int. Cl. A01K 11/00; A61D 3/00; A61D 7/00

(52) U.S. Cl. CPC A01K 11/006; A61D 7/00; A61D 3/00; A01K 11/005

(57) ABSTRACT

A system for attaching a radio frequency identification (RFID) tag to an animal when received thereby. The system is configured for mounting thereto a RFID tag magazine comprising a plurality of cannulas that each contain at least one RFID tag (15), wherein the RFID tag magazine is configured for presentation of any one of the plurality of cannulas to the animal when so received.

### TECHNICAL FIELD

The disclosure herein generally relates to systems and methods for attaching identification information to an animal.

### BACKGROUND

Animals including laboratory animals generally need to be identified. An animal may be tattooed with identity information in the form of a plurality of symbols, have an identity tag attached, or have an ear notched. The identity of animals may be determined by inspecting the ear identification notches, attached tag, or tattoo, which may be relatively expensive and time consuming, especially if there are many animals to be marked. There may be a hundreds or thousands of animals in a research facility, making manual marking and recording the identities unattractive. Radio frequency identified tags may be externally attached to an animal so that it can be identified. An RFID tag may be attached to an ear of an animal, for example. This may be time consuming and/or difficult in some circumstances, for example when attaching RFID tags to hundreds or thousands of mice in a facility.

In the context of this specification, an animal may be generally any suitable non-human animal or human, including a laboratory animal, a rodent, a rat, a mouse, a cat, a dog, a rabbit, a bird including a poultry bird, livestock including cattle, sheep and horses, a zoo animal or generally any type of animal.

### SUMMARY

Disclosed herein is a system for attaching a radio frequency identification (RFID) tag to an animal when received thereby. The system is configured for mounting thereto a RFID tag magazine comprising a plurality of cannulas that each contain at least one RFID tag. The RFID tag magazine is configured for presentation of any one of the plurality of cannulas to the animal when so received.

An embodiment is for implanting the RFID tag to the animal.

In an embodiment, the plurality of cannulas each comprise a plurality of RFID tags. Alternatively, the plurality of cannulas each comprise a single RFID tag.

An embodiment is configured for rotationally mounting thereto the tag magazine.

In an embodiment, the RFID tag magazine comprises a fluted rotor having a plurality of flutes in which the plurality of cannulas are received for sliding presentation of any one of the plurality of cannulas to the animal when so received.

An embodiment comprises cannula actuator engagable with a selected cannula of the plurality of cannulas, and when so engaged with the selected cannula, slidingly present the selected cannula to the animal when so received.

An embodiment comprises a plunger movable within any one of the plurality of cannulas for positioning the RFID tag.

An embodiment comprises:
a cannula actuator engagable with a selected cannula of the plurality of cannulas, and when so engaged with the selected cannula, slidingly present the selected cannula to the animal when so received;
a plunger movable within any one of the plurality of cannulas for positioning the RFID.

An embodiment is to withdraw the cannula actuator while holding the plunger stationary such that the RFID remains stationary.

Disclosed herein is a RFID tag magazine for a system for attaching a RFID tag to an animal when received thereby. The RFID tag magazine comprises a plurality of cannulas that each contain at least one RFID tag wherein the magazine is configured for presentation of any one of the plurality of cannulas to the animal when so received.

In an embodiment, the plurality of cannulas each comprise a plurality of RFID tags.

In an embodiment, the plurality of cannulas each comprise a single RFID tag.

In an embodiment, the tag magazine is configured for rotational mounting within the system.

An embodiment is configured for rotationally mounting the system for attaching a RFID tag to the animal when received thereby.

An embodiment comprises a fluted rotor having a plurality of flutes in which the plurality of cannulas are received for sliding presentation of any one of the plurality of cannulas to the animal when so received.

Disclosed herein is a system for marking an animal when received thereby. The system is configured for mounting thereto a tattooing needle magazine comprising a plurality of tattoo needles. The magazine is configured for presenting any one of the plurality of tattoo needles to the animal when so received.

An embodiment comprises a tattoo needle holder to which any one of the plurality of tattoo needles may be held and subsequently removed from the tattooing needle magazine.

In an embodiment, the tattooing needle magazine comprises a housing and a carousel housed in the housing, and the plurality of needles are attached to the carousel. The housing may define an opening for passage of the plurality of needles.

An embodiment comprises at least one of a plurality of ink receiving portions and a needle cleaning fluid reservoir.

In an embodiment, the mark is human readable.

Disclosed herein is a tattooing needle magazine for a system for marking an animal when received thereby. The tattooing needle magazine comprises a plurality of tattoo needles, wherein the magazine is configured for presenting any one of the plurality of tattoo needles to the animal when so received.

An embodiment is configured for a tattoo needle holder to remove any one of the plurality of tattoo needles from the tattooing needle magazine.

An embodiment comprises comprising a housing and a carousel housed in the housing, wherein the plurality of needles are attached to the carousel. The housing may define an opening for passage of the plurality of needles.

Disclosed herein is a system for attaching identification information to an animal. The system comprising a system for attaching a RFID tag to the animal. The system comprises a system for marking an animal. The system comprises a controller for controlling the system for attaching the RFID tag and the system for marking the animal.

An embodiment is configured for receiving at least one further system for attaching a RFID tag and at least one further system for marking an animal. The mark may be human readable.

In an embodiment, the mark comprises a plurality of symbols encoding the identification information.

In an embodiment, the system for attaching a RFID tag to the animal comprises an RFID attachment module, and the system for marking the animal comprises an animal marking module, and the controller comprises a control module.

In an embodiment, the RFID attachment module, the animal marking module and the control module are fastened together.

An embodiment comprises a plurality of RFID attachment modules and a plurality of animal marking modules.

In an embodiment, the plurality of RFID attachment modules, the plurality of animal marking modules, and the control module are fastened together.

In an embodiment, the controller causes the magazine rotor of the RFID tag to rotate after the presented cannula has been empties of RFID tags, and present another cannula having at least one RFID tag.

In an embodiment, the controller is in communication with a computing device, and the controller is configured to send identification information attached to the animal to the computing device for storage in a datastore.

An embodiment comprises a plurality of motors operationally coupled to at least some of the RFID tag magazine, the carousel, the plunger and the cannula actuator.

In an embodiment, the controller rotates the carousel and presents a tattoo needle and when the tattoo needle completes a predefined number of tattoos or tattoo characters, the controller rotates the carousel and presents another tattoo needle.

Disclosed herein is a device for restraining the tail of an animal, the device comprising a platform for receiving the body of the animal and a tail gripping channel arranged for receiving therein a proximal portion of the tail.

In an embodiment, the tail gripping channel comprises resilient grips that close on the tail when received thereby.

An embodiment comprises a tail clip disposed across the tail gripping channel.

Disclosed herein is a method for attaching a radio frequency identification tag to an animal, the method comprising the steps of:

presenting a cannula to an animal received by a system for attaching a RFID tag to the animal; and
operating the system for attaching the RFID tag.

Disclosed herein is a method for marking an animal, the method comprising the steps of:
presenting a tattoo needle to an animal received by a system for marking the animal; and
operating the system for marking the animal.

Disclosed herein is a method for attaching identification information to an animal, the method comprising at the steps of at least one of:
the method for attaching a radio frequency identification tag to the animal; and
the method for marking an animal defined by claim.

In the various disclosure above, the RFID tag or each of the plurality of RFID tags can be interrogated by a RFID reader to derive identification information.

Disclosed herein is non-transitory processor readable tangible media including program instructions which when executed by a processor causes the processor to perform a method disclosed above.

Disclosed herein is a computer program for instructing a processor, which when executed by the processor causes the processor to perform a method disclosed above.

Any of the various features of each of the above disclosures, and of the various features of the embodiments described below, can be combined as suitable and desired.

### BRIEF DESCRIPTION OF THE FIGURES

Embodiments will now be described by way of example only with reference to the accompanying figures in which:

FIGS. 1 and 2 show a front perspective view and a side perspective view respectively of an embodiment of a system for attaching identification information to an animal.

FIG. 3 shows the tail of the animal having identification information attached thereto.

FIG. 4 shows an exploded view of the system of FIG. 1.

FIG. 5 shows a detail of an embodiment of a system, of the system of FIG. 1, for attaching a RFID tag to the animal of FIG. 3 and an embodiment of a system for marking the animal of FIG. 3.

FIG. 6 shows a perspective view of an embodiment of RFID tag magazine.

FIG. 7 shows a perspective view of the tag magazine of FIG. 6.

FIG. 8 shows a bottom view of the example RFID tag disposed within a cannula.

FIG. 9 shows the RFID tag of FIG. 8 exiting the cannula with the assistance of a plunger.

FIGS. 10 and 11 show front and back perspective views respectively of an embodiment of a tattooing needle magazine.

FIG. 12 shows an example of an ink cartridge.

FIG. 13 shows a front perspective view of a base of the system of FIG. 1.

FIG. 14 shows examples of removable animal holders received by the system of FIG. 1.

FIG. 15 shows perspective views of a plurality of examples of removable animal holders.

FIGS. 16 and 17 show perspective and plan views of a plurality of example animal holders of FIG. 15.

FIG. 18 shows a schematic side view of another embodiment of a tag magazine used in conjunction with an example tale fastener to implant an RFID within the upper side of the animal's tail.

FIG. 19 shows a schematic side view of the tag magazine of FIG. 18 used to implant an RFID within the underside of the animal's tail.

FIG. 19 shows a schematic side view of the tag magazine of FIG. 18 used in conjunction with an example tale fastener to implant an RFID within an underside of the animal's tail.

FIGS. 21 to 23 show cut away elevational views of the tag magazine of FIG. 18 during various steps in an example of a method of operating the tag magazine, wherein in FIG. 22 outwardly biased wings of a cannula moved outwardly when the cannula is being presented to the animal.

FIG. 24 shows a top view of a cannula of the tag magazine of FIG. 18, in a free state, wherein outwardly biased wings in the form of polymer wings thereof have moved outwardly.

FIG. 25 shows a top cutaway view of the tag magazine of FIG. 18 showing the cannula of FIG. 24 wherein the wings are held inwardly by the tag magazine.

FIG. 26 shows a cutaway elevational views of the tag magazine of FIG. 18 with a spent cannula being ejected from the tag magazine into a waste receptacle.

FIGS. 27 to 31 show schematic diagrams another embodiment of a tag magazine in the form of a drum tag magazine wherein the plurality of cannula and each collocated with outwardly biasing spring in a tunnel of a drum.

FIGS. 32 to 37 show schematic diagrams another embodiment of a tag magazine in the form of a spiral tag magazine.

FIG. 38 shows an embodiment of a tale fastener for fastening the tail while disposing the RFID tag within the underside of the tale.

FIG. 39 shows another embodiment of a tale fastener for fastening the tail while disposing the RFID tag within the underside of the tail.

### DESCRIPTION OF EMBODIMENTS

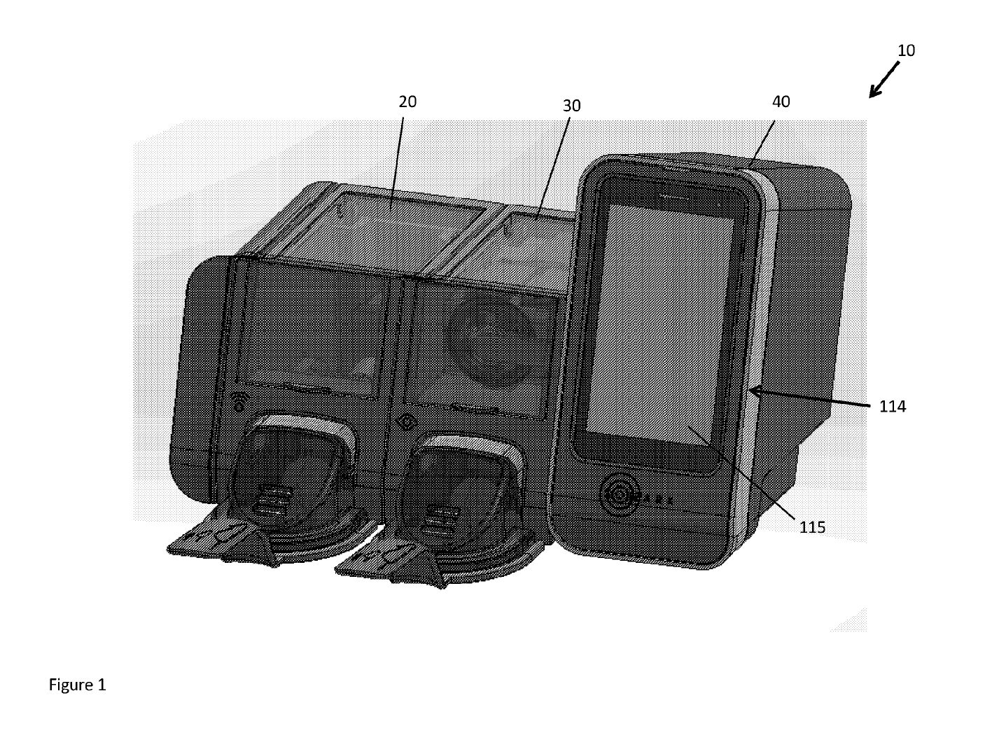

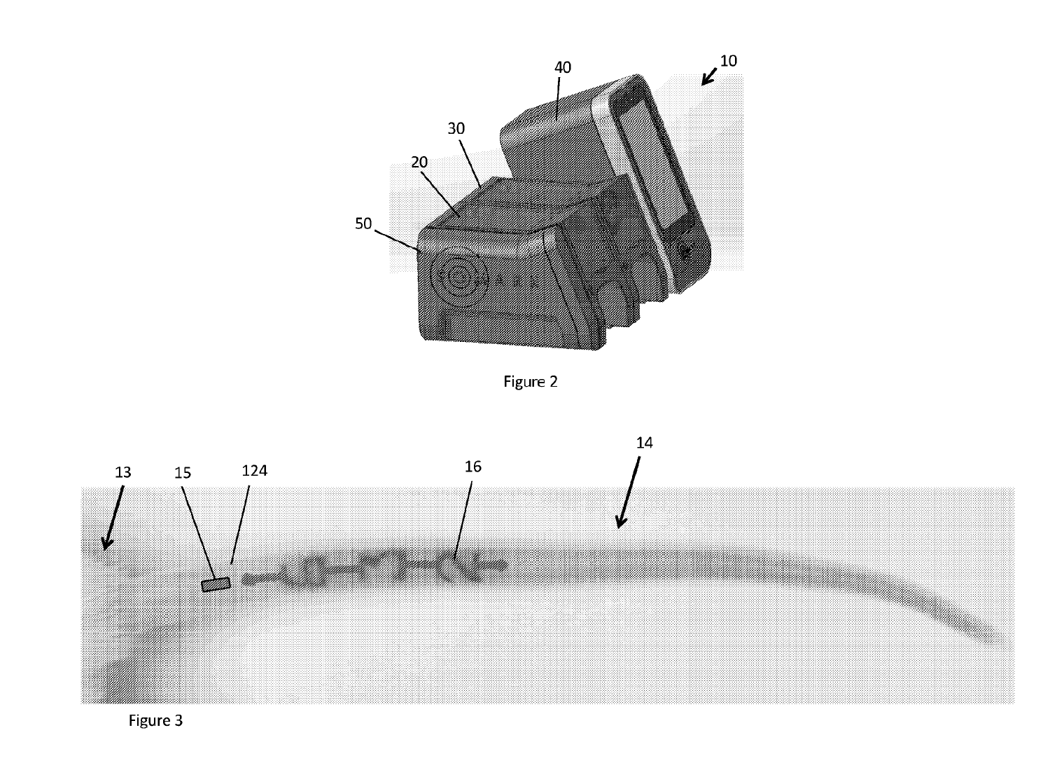

FIGS. 1 and 2 show a front perspective view and a side perspective view respectively of an embodiment of a system for attaching identification information to an animal, the system being generally indicated by the numeral 10. FIG. 3 shows the tail 14 of the animal 13. The tail 14 has a mark 16 in the form of a tattoo applied thereto by the system 10. The tail 13 has a RFID tag 15 attached thereto by the system 10. The animal 13 is a non-human animal, in this example a rodent in the form of a rat, however the animal 13 may be any suitable non-human animal including a mouse, a dog or a monkey.

A RFID reader can interrogate the RFID tag 15 attached to the animal 13 to derive identification information indicative of the identification of the animal. A person may read the mark 16, which may be indicative of the identification of the animal or some other information. Applications of the attached RFID tag 15 and/or mark 16 include identification of non-human animals in research laboratories and facilities, for example, during preclinical trials or behavioural experiment's. The research laboratories or facilities may have hundreds or thousands of animals.

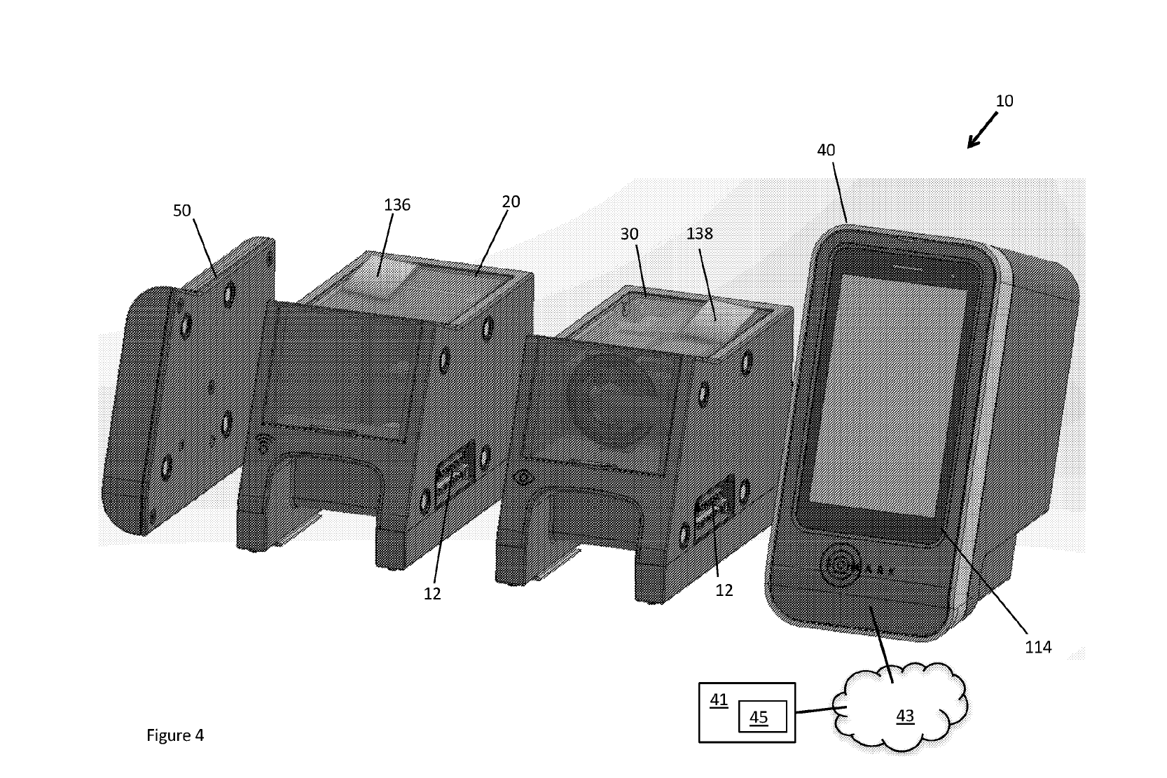

The system 10 comprises a system 20 in the form of an RFID attachment module for attaching a RFID tag 15 to the animal 13 when received thereby. The system 10 comprises a system 30 in the form of a marking module for marking the animal 13 when received thereby. The system 10 comprises a controller 40 in the form of a control module for controlling the system 20 for attaching the RFID tag 15 and controlling the system 30 for marking the animal 13. FIG. 4 shows an exploded view of the system 10, in which the marking module 30, the RFID attachment module 20, and the controller 40 are shown to each be a module of the system 10. The system 10 may comprise a plurality of marking modules 30 and/or a plurality of RFID attachment modules 20. Using a plurality of at least one of the systems 20,30 in a system for attaching identification information to an animal may allow a user to pipeline the attachment of identification to a plurality of animals, and process more than one animal simultaneously, which may increase the rate of attaching identification information to a plurality of animals. For example, after a first animal is tagged by system 20 and subsequently received by system 30 for marking, a second animal may be simultaneously received by system 20 for tagging. RFID read 138 may interrogate a RFID tag implanted by system 20 to derive identification information that the system 30 subsequently attaches to the animal 13. Alternative embodiments may comprise one or more RFID attachment modules 20 but no marking modules 30. Other alternative embodiments may comprise one or more marking modules 30 but no RFID attachment modules. Yet another embodiment may comprise a system 20 for attaching a RFID tag 15 to the animal 13, the system 20 not being a module, and a system 30 for marking the animal 13, the system 30 not being a module. That is, while the system 10 is modular, other embodiments of a system for attaching identification information to an animal 13 may not be modular and may have integral systems for attaching the RFID and marking the animal 13.

Generally, the systems 20,30 and the controller 40 may be fastened together to form system 10. Alternatively, the systems may be separated and in communication with each other by a point-to-point connection or via a network.

Communications connectors 12 in the form of UBS or serial connectors, for example, are provided on the sidewalls of the systems 20,30 and the controller 40. The communication connectors fasten the modules together and enable inter-module communications. Alternatively, the connectors 12 may be mechanical connectors for fastening the modules 20, 30, 40 together and communication is wireless, for example at radio frequencies using a BLUETOOTH protocol or generally any suitable protocol. The connectors 12 communicate information including control instructions to the systems 20,30 from the control module 40 and provide telemetry. A capping unit 50 is at one end of the system 10, and the controller 40 is at the other end, however in other embodiments the controller 40 may be in the middle of the system 10, for example, and there may not be a capping unit 50. The controller 40 is powered by mains electricity, but may alternatively be powered by an internal battery. The controller 40 in this but not necessarily in all embodiments supplies electrical power to the systems 20, 30. Electrical power may be supplied to the modules 20,30 via connectors 12.

The controller 40 has a communications interface 39 comprising a physical communications interface and is connected to one of a computer network 43, internetwork or point-to-point connection via the physical communications interface. The controller 40 is connected to a computing device 41 via a computer network 43, internetwork, or point-to-point connection. The network 43 may be a personal area network (e.g. a Universal Serial Bus network, a BLUETOOTH network, a FireWire network), a packet-switched network, a local area network (e.g. an Ethernet network defined by the standard IEEE 802.3 or a variant thereof, a Wi-Fi network defined by the standard IEEE 802.11 or a variant thereof, a Fibre Channel network), a metropolitan area network, a wide area network (e.g. packet over SONET/SDH, MPLS, Frame Relay), or a meshed radio network, for example, a ZIGBEE or DUST network, or any other suitable network. The internetwork may comprise a plurality of networks of any suitable type. The control module 40 can communicate with the computing device 41. The computing device is configured to receive from the control module 40 the identification information marked on the animal 13 and written to the RFID tag 15 attached to the animal 13. The identification information may be stored in an electronic datastore 45 in the form of an electronic database or electronic file. The datastore may be accessed by a machine or a user to determine information about an animal by using the animal's identification information.

Generally, the controller 40 causes the system 10 to automatically attach the RFID tag 15 to the tail 14 of the animal 13 and the system 10 to automatically mark the tail 14 of the animal 13. The mark in the form of a tattoo 16 generally comprises at least one symbol (for example, 1, 2, 3, 4 or more characters which may form of string of symbols), for example at least one of the ASCII characters, Chinese characters, or generally any suitable symbol. The at least one symbol generally but not necessarily is indicative of the identity of the animal 13. Alternatively, the identity information may be encoded, for example, as a bar code.

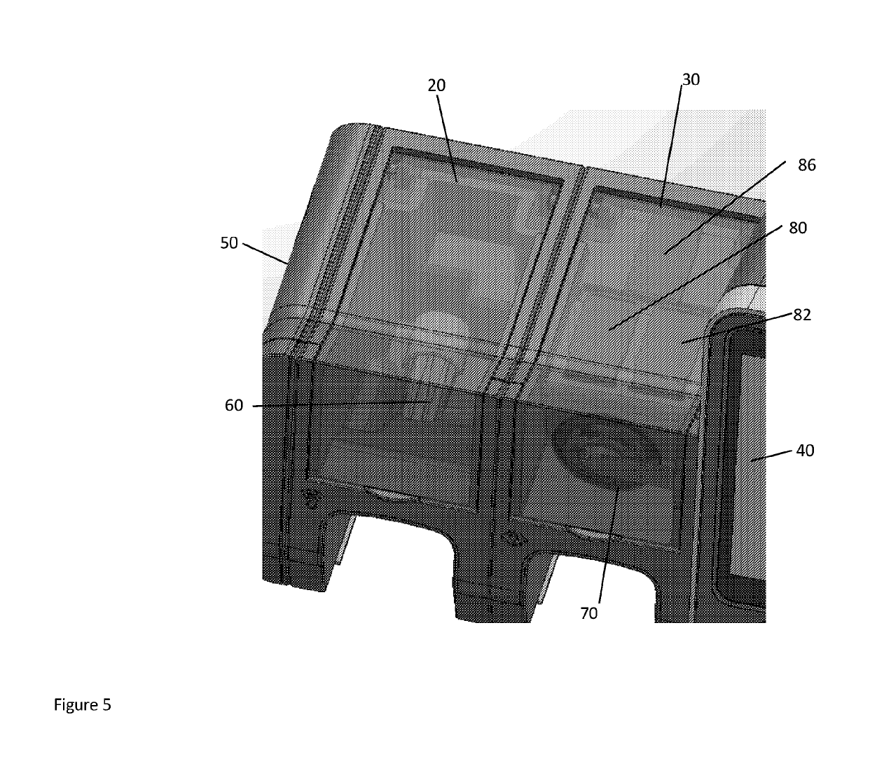

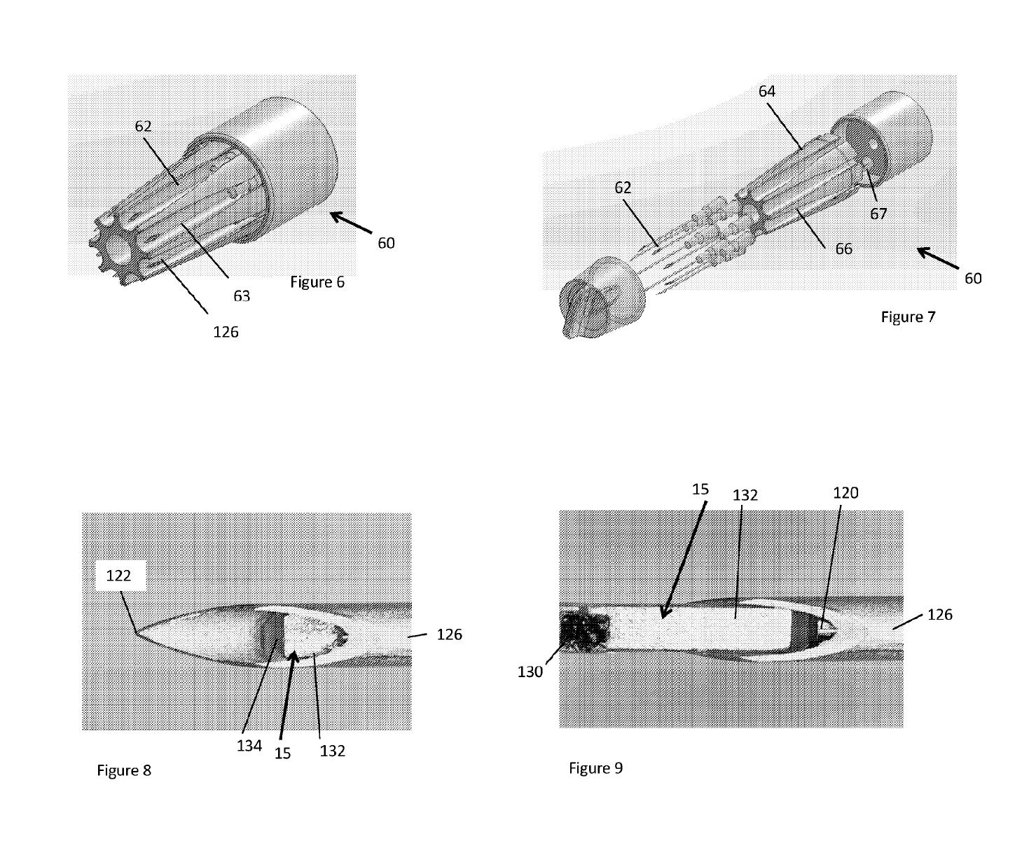

FIG. 5 shows a detail of the system 20 for attaching a RFID tag 15 to the animal 13 when received thereby, and the system 30 for marking the animal 13 when received thereby. The system 20 is configured for mounting thereto a tag magazine 60. The tag magazine 60 is a rotary magazine. FIG. 6 shows a perspective view of the tag magazine 60, the tag magazine being shown in exploded perspective view in FIG. 7. The tag magazine 60 comprises a plurality of cannulas 62 that each has disposed therein at least one RFID tag 15. The tag magazine 60 is configured for presentation of any one of the plurality of cannulas to the animal 13 when so received. The plurality of cannula 62 are for implanting RFID tags in a plurality of animals. While the plurality of cannulas 62 each have disposed therein a plurality of RFID tags, they may each only contain one RFID tag 15. The tag magazine 60 is configured to be rotationally mounted at system 20. The controller 40 causes the magazine 60 to rotate the cannula presented cannula has been emptied of RFID tags, optionally withdrawing the cannula by sliding the cannula back into a flute 66, and subsequently presenting another cannula 63 having at least one RFID tag therein can be presented to the animal. The controller 40 indicates by sending a message to the computing device 41, flashing a light, or making a sound when all of the RFID tags 15 in all the cannulas 62 have been spent.

FIG. 8 shows a bottom view of the RFID tag 15 disposed within a cannula 126 of the plurality of cannulas 62. FIG. 9 shows the RFID tag 15 of FIG. 8 exiting the cannula 126 with the assistance of a plunger 120 in the form of an actuatable pin, which is disposed within the cannula 62. The plunger 120 is in contact with an end of the RFID tag 15 or is in contact with a RFID tag within the cannula 62 that is furthest from the distal end of the cannula. The sharp point 122 of the cannula 126 pierces the epidermis of the skin 122. The cannula 62 may be pushed into the skin 124 to form a tunnel therein, with the tip 122 of the cannula 126 separating the skin. The RFID tag 15 may be pushed longitudinally along the cannula 126 by action of the plunger 120 disposed in the cannula 126 (specifically inside the lumen of the cannula) towards the torso of the animal 13 for a distance of 5-6 mm. The RFID tag 15 may be implanted below the basal layer of the epidermis, in the dermis, leaving a 1-2 mm space behind the RFID tag 15 for the opening in the skin 124 to close and the skin 124 to heal. In this embodiment, however, the cannula 62 is pushed 5-6 mm beneath the epidermis then the cannula 62 is withdrawn while the plunger 120 is stationary. The plunger retains the position of the RFID tag 15 while the cannula 126 is withdrawn. Alternatively, the action of the plunger 120 in the cannula 64 may push the RFID tag 15 through the cannula 126 to the distal end thereof and out thereof into the dermis below the basal layer. The plunger 120 may push the RFID tag 15 for a distance of 3-4 mm out of the cannula 62, which is then withdrawn.

The tag magazine 60 comprises a fluted rotor 64 having a plurality of flutes 66 in which the plurality of cannulas 62 are received for sliding presentation of any one of the plurality of cannulas to the animal 13 when so received. The system 20 has a cannula actuator in the form of a tube 121 operationally couple to the magazine 60 for pushing the cannula 62 outwardly, out of the flute 66 that sheaths the cannula, and subsequently withdrawing the cannula when the RFID tag therein are spent. The plunger 120 is disposed within the tube 121.

The system 20 has at least one RFID reader 136 in communication with the controller 40. The RFID reader 136 is cooperates with the controller 40 to validate the RFID tag 15 before, during or after implantation thereof. The controller 40 triggers the RFID reader 136 to write to the RFID tag 15 the animal identification information indicative of the identity of the animal 13. The animal identity information may comprise the information conveyed by the mark, which in this but not all embodiments comprises the symbols tattooed on the animal 13. Also written to the RFID tag 15 may be enclosure information indicative of the identity of an enclosure in which the animal 13 is associated with (for example, will be disposed), a study protocol identifier to which the rodent belongs and any other information that maybe written to the user memory of the RFID tag 15.

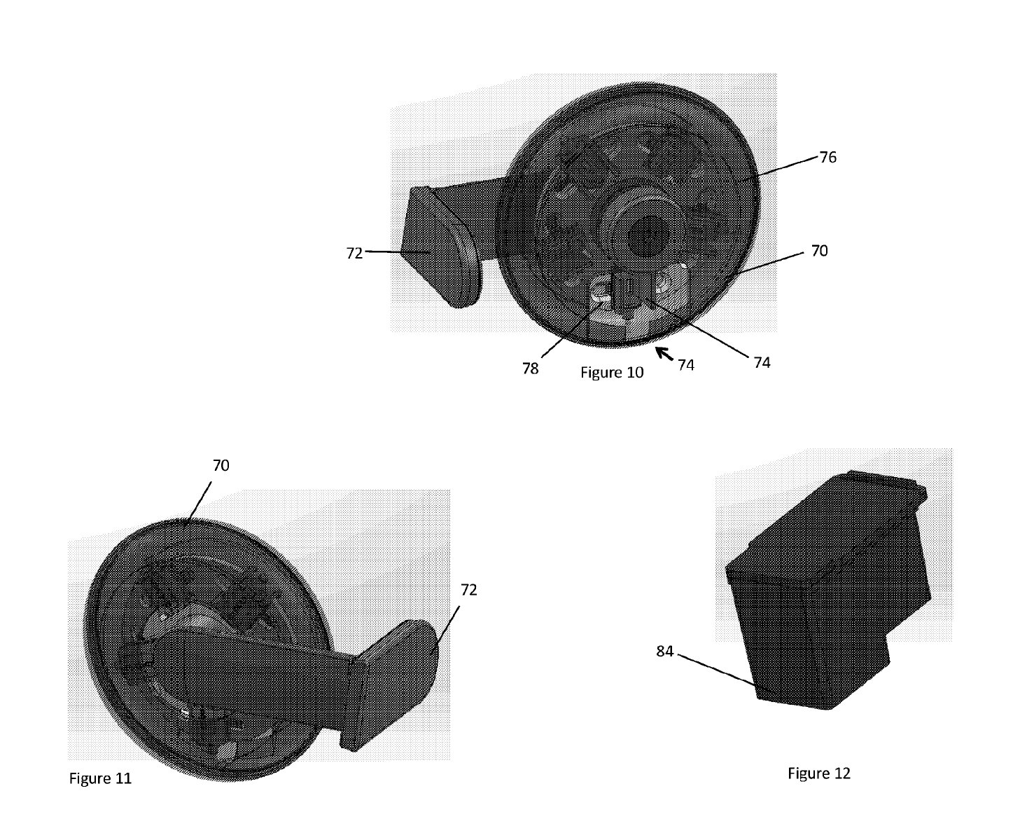

FIGS. 10 and 11 show front and back perspective views respectively of a tattooing needle magazine 70. The system 30 for marking an animal 13 when received thereby is configured for mounting therein the tattooing needle magazine 70. The tattooing needle magazine 70 is rotationally mounted on an arm 72. The tattooing needle magazine 70 comprises a plurality of tattoo needles 74. The magazine 70 is configured for attachment of any one of the plurality of tattoo needles 74 to a tattoo needle holder for presenting a tattooing needle held thereto to the animal 13 when so received. The tattooing needle magazine 70 comprises a housing 76 and a carousel 78 housed in the housing 76. The plurality of needles are removable attached to the carousel 78. The housing 76 defines an opening 79 for passage of the plurality of needles 74.

The system 30 comprises a plurality of tattoo ink receiving portions 80, 82 in the form of tattoo ink cartridge recesses which are each configured to receive a tattoo ink cartridge 84 in the form of a sealed tattoo ink cartridge. FIG. 12 shows an example of a tattoo ink cartridge 84 for receipt by the tattoo ink cartridge receivers 80, 82. The tattoo ink receiving portions 80, 82 may alternatively be in the form of ink reservoirs. The ink is presented to the tip of a needle in precise measures for each pixel of the tattoo character to be applied to the skin. The system 30 has an ink pump configured to dispense a predetermined volume of ink via an ink conduit in communication with the tattoo needle to the tip of the needle or onto the skin of the rodent preceding the needle tip. The system 30 comprises a cleaning fluid receiving portion 86 configured to receive a tattooing needle cleaning fluid. The cleaning fluid may be transported via a cleaning fluid conduit to the needle. A cleaning tool may be received by the system 20, and the needle applied to the cleaning tool. The cleaning tool may simulate an animal's tail, and may comprise a soft polymer material.

The systems 20, 30 comprise a plurality of motors for moving and are operationally coupled to the tag magazine, the carousel 78, the tattoo needles, the plunger, the cannula actuator, and operate the ink pump system and the cleaning fluid pump system. A computer program causes the controller 40 to operate the actuators.

The controller 40 has non-transitory processor readable tangible media including program instructions which when executed by a processor within the controller, causes the controller to perform an embodiment of a method. The controller may control at least one of (a) the characters of a tattoo applied to the animal 13, and where the characters are sequential, which device applies which symbols and the order in which the symbols are applied, and (b) the order in which either a tattoo or RFID tag 15 is applied to the tail 14.

The controller 40 rotates the carousel 78 to present a selected needle for tattooing until it has completed a predefined number of tattoos or tattoo characters or is worn, after which the controller rotates the next selected needle into position. The controller continues to rotate unused needles into position until all the used needles are used. The controller 40 then indicates on the user interface that a new tattooing needle magazine is to replace the received magazine 70. The controller 40 presents information about the progress of the tattoo application and RFID tag 15 attachment and other information on a user interface 114. The user interface comprises an electronic display 115.

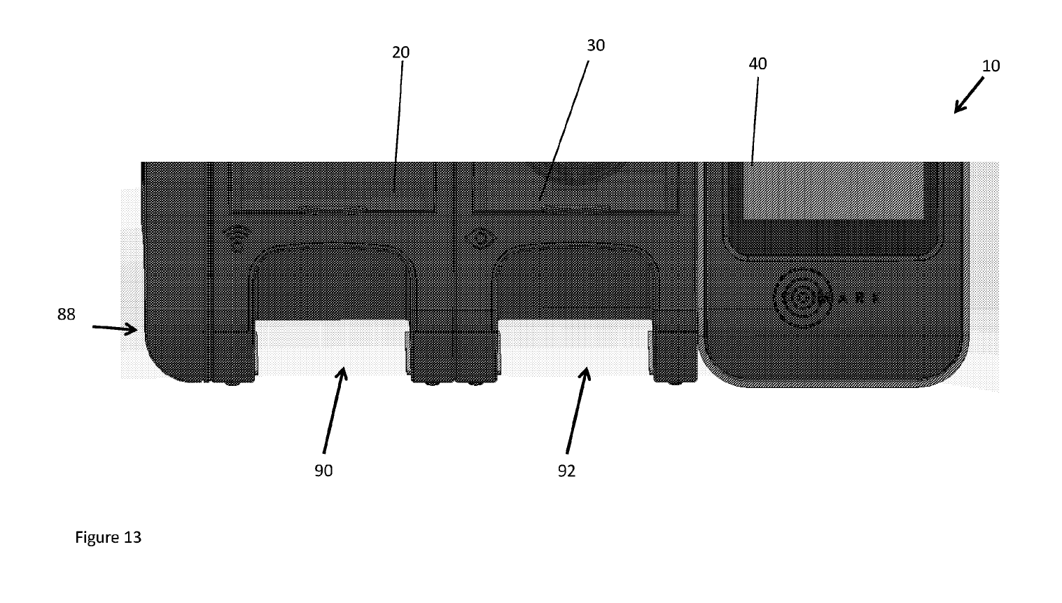

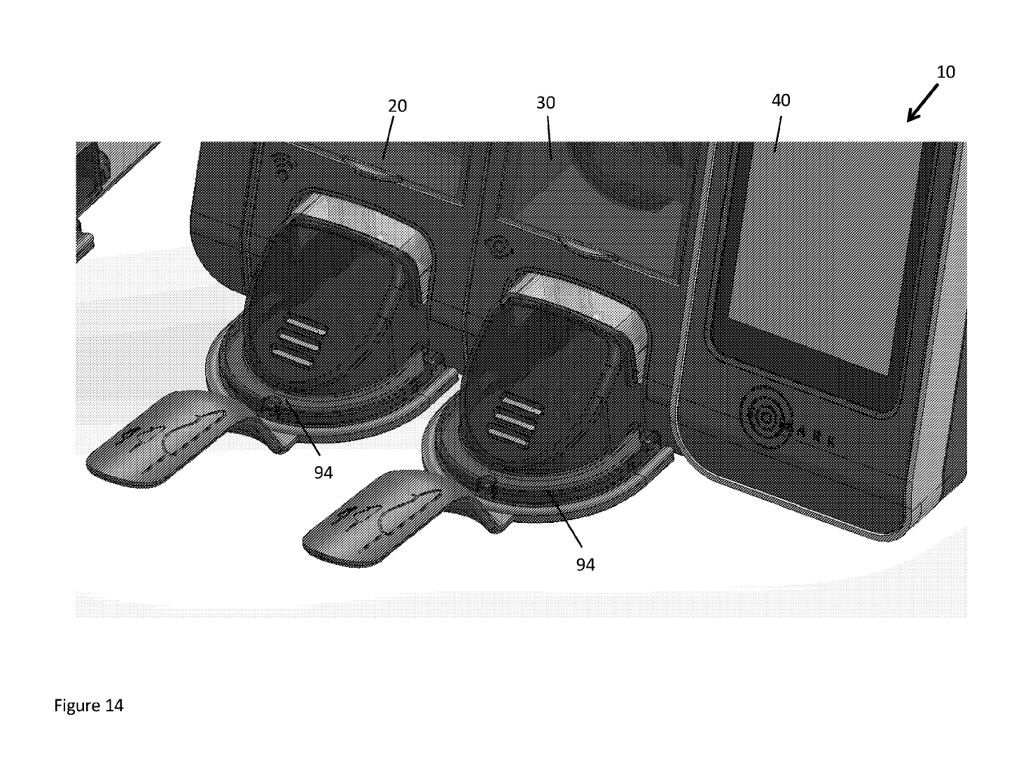

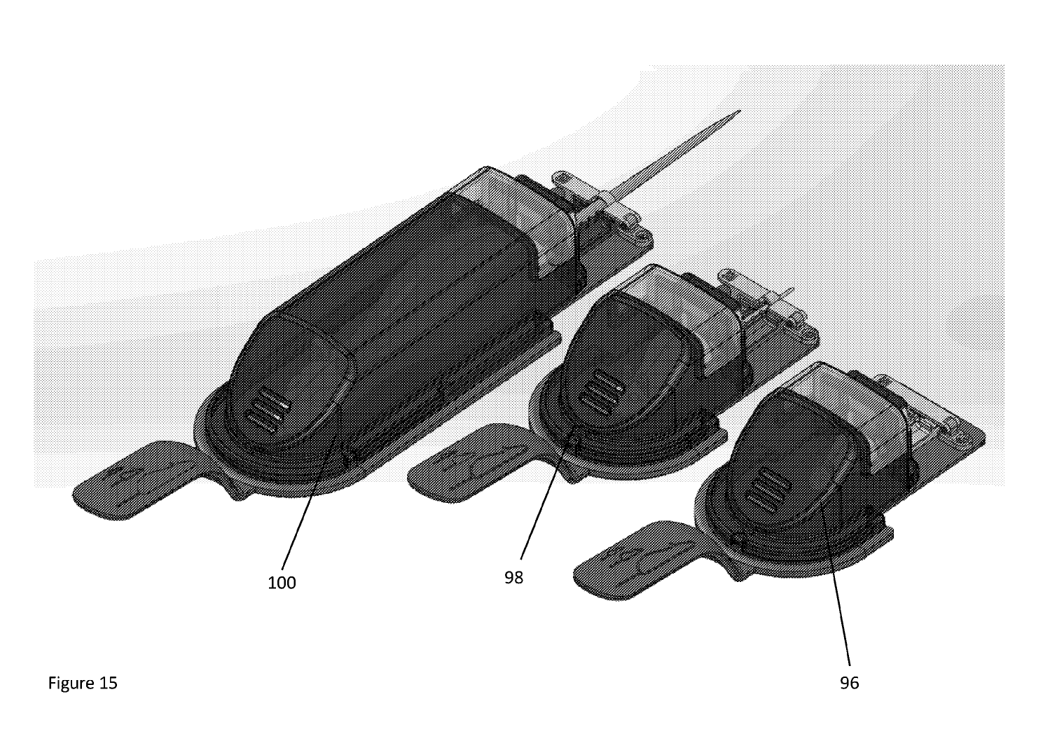

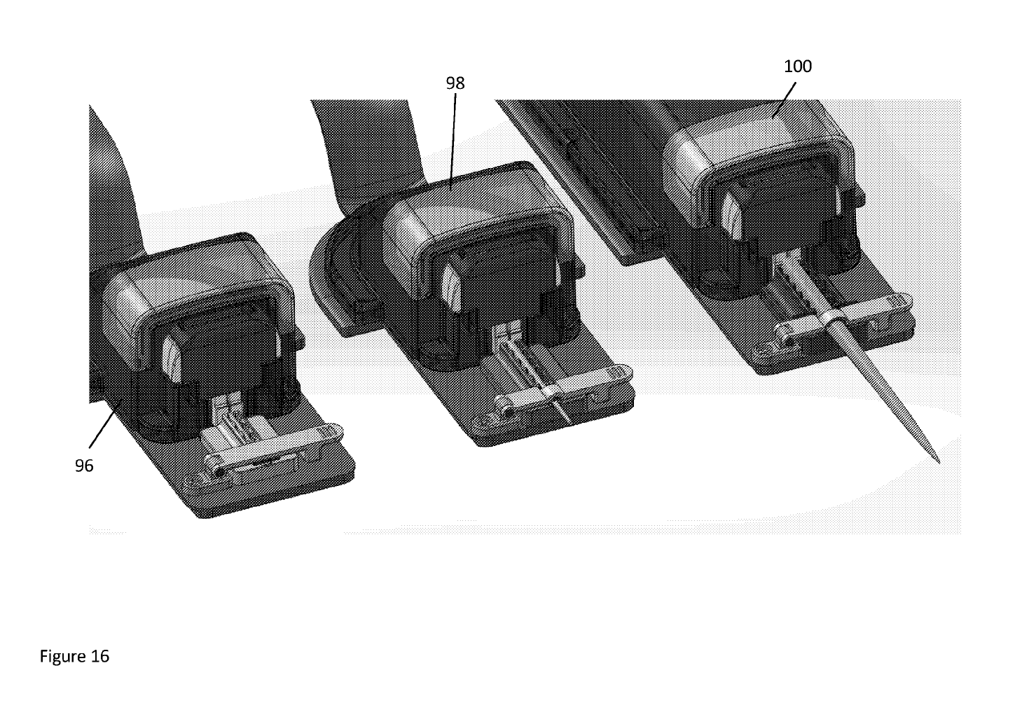

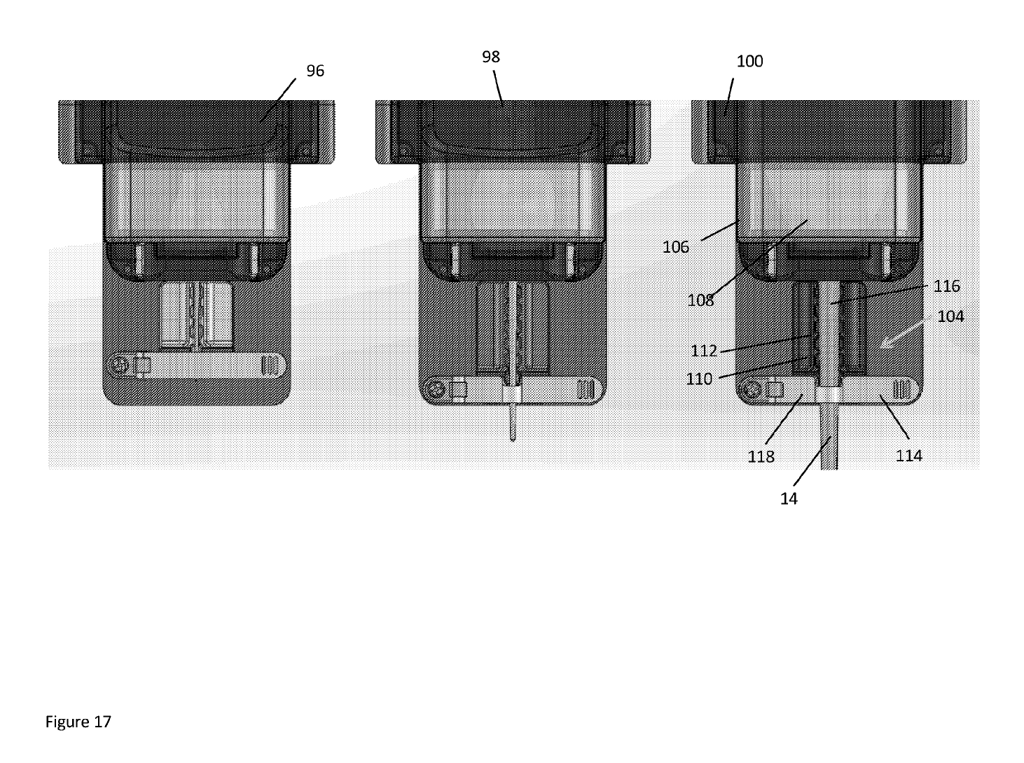

FIG. 13 shows a front perspective view of a base 88 of the system 10 wherein each of system 20 and 30 define a tunnel 90, 92 for receiving a removable animal holder. FIG. 14 shows examples of removable animal holders 94 received by the system 10. The removable animal holders 94 are received by the tunnels 90, 92 of the system 10. FIG. 15 shows perspective views of a plurality of examples of removable animal holders 96, 98 and 100. The plurality of animal holders 96, 98 and 100 are not all identically sized. Animal holder 100 is for an adult rat, animal holder 98 is for an adult mouse, animal holder 96 is for a juvenile mouse, for example. FIGS. 16 and 17 show perspective and plan views of a plurality of the example animal holders of FIG. 16. The removable animal holders 96, 98, 100 each have a tail fastener 104 for restraining the tail 104 of an animal 13. A platform 106 receives the body 108 of the animal 13. The tail fastener 104 comprises a tail gripping channel 110 arranged for receiving therein a proximal portion 116 of the tail 13. The tail gripping channel 110 comprises resilient grips 112 in the form of teeth comprising silicone that close on the tail when received thereby. The tail fastener 104 comprises a tail clip 114 disposed across the tail gripping channel 110. The clip 114 is for the distal end of the tail 102. The clip 114 comprises a hindgedly attached bar 118 and is fastened, for example magnetically fastened by a magnet or mechanically fastened with a clip, at a distal end of the tail. The tail 14 when received is straight and the tail skin 114 is presented for attaching the identification information on the upper side of the tail.

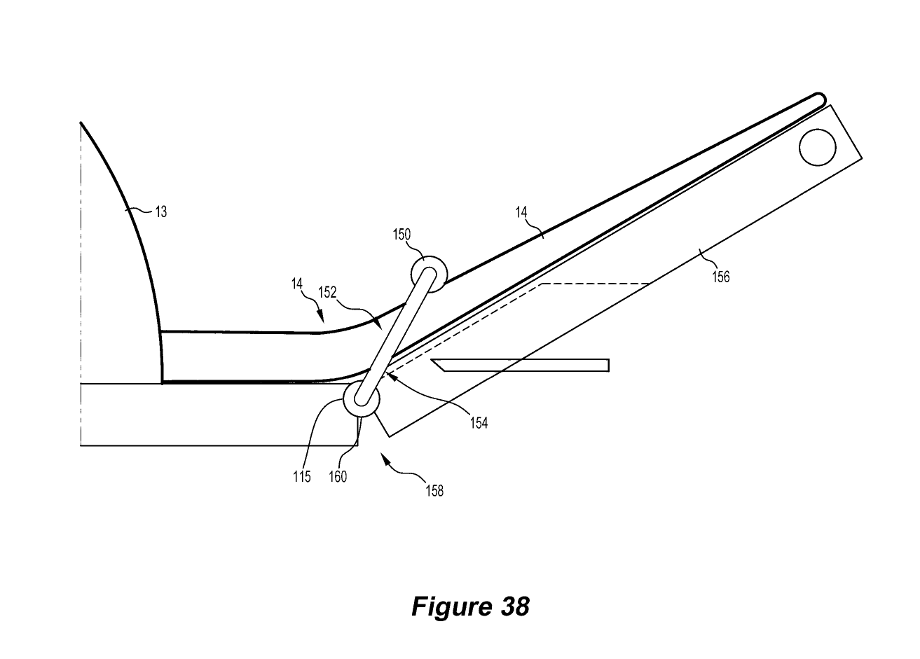

In an embodiment of an animal holder 168 shown in FIG. 38, a tail clamp 152 having a soft roller 150 on a movable arm 154 clamps the tail 14 onto a hinged paddle 156. The movable arm is biased into the paddle by a biasing element in the form of a coil sprint 160. The soft roller 150 comprises a material such as foam or silicone. Operation of the animal holder may comprise the following steps:
1. The tail is laid down a groove inset into the paddle 156.
2. The tail 14 is inserted under the soft roller 150 by the operator.
3. Insertion of the paddle 156 into a tunnel 90, 92 will automatically hinge the paddle, allowing clearance for the cannula for attaching the identification information on the lower side of the tail 14.
4. Upon removal of paddle the tail and soft roller will return to a horizontal surface

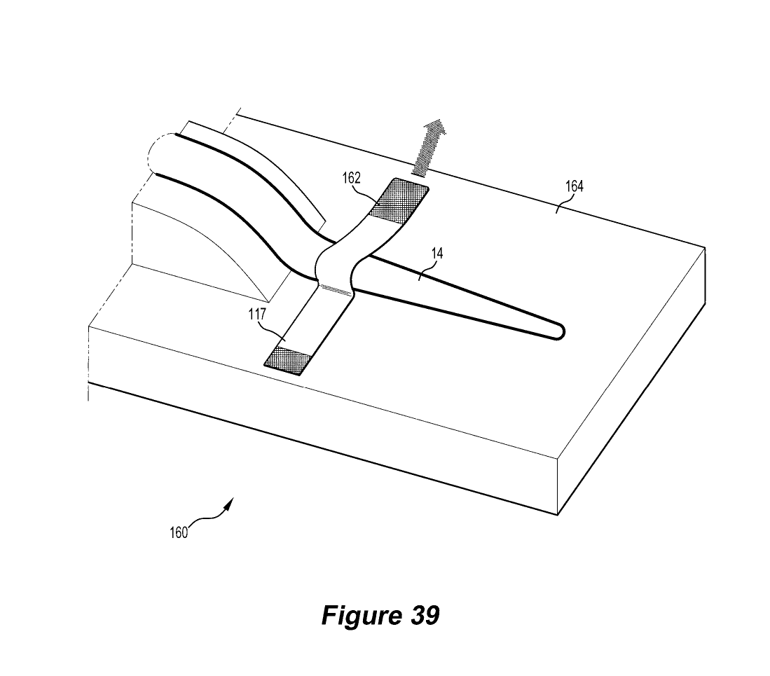

In an embodiment at an animal holder 160 shown in FIG. 39, a soft elastic strap 117 is stretched over the tail 14 with the strap end being secured by a hook and loop closure 162 (continuous) or a series of hooks (discrete). In this embodiment, the operation may comprise the following steps:
1. The tail is laid down a groove inset into the paddle 164.
2. The strap 117 is stretched over the tail 14.
3. Tension in the strap 117 is adjusted.
4. The strap is released by the operator after removal from garage tunnel.

The body 108 is restrained on the platform so that it does not move from the platform and the rodent tail is gripped immediately after the torso to ensure the tail is restrained in a precise at known position.

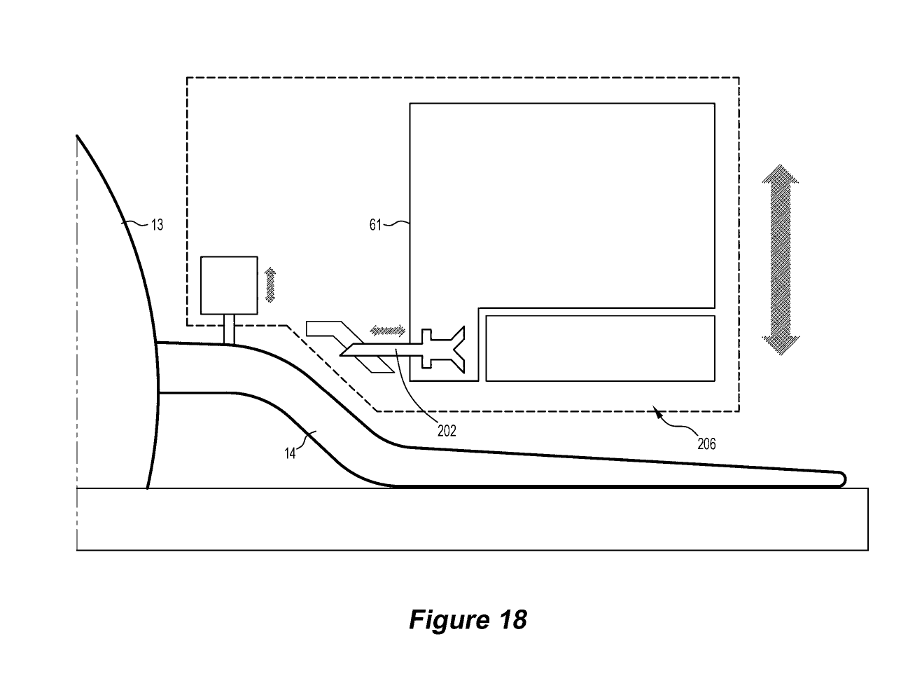

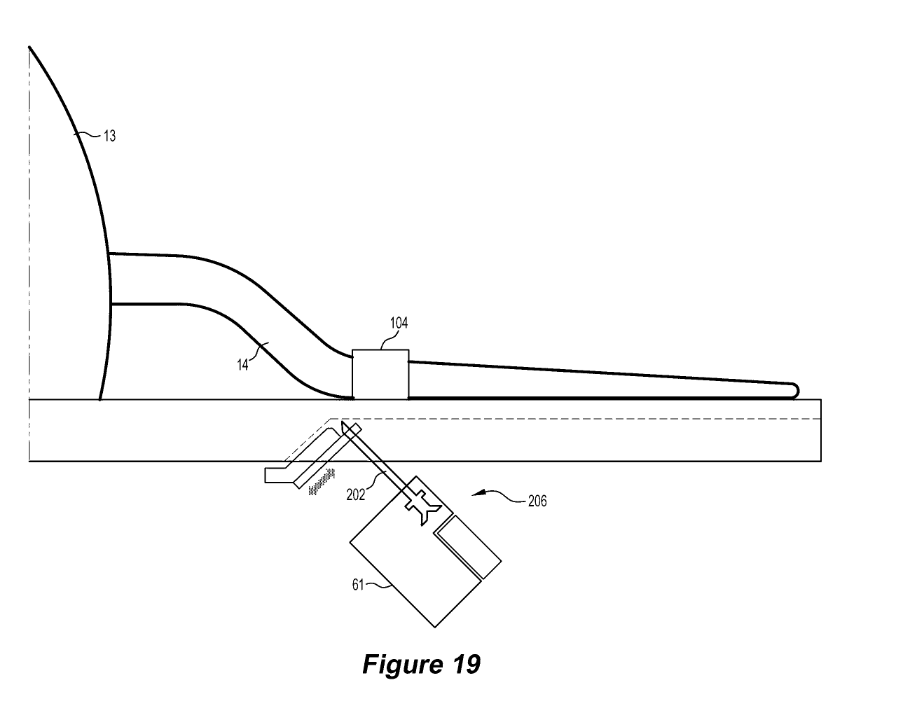

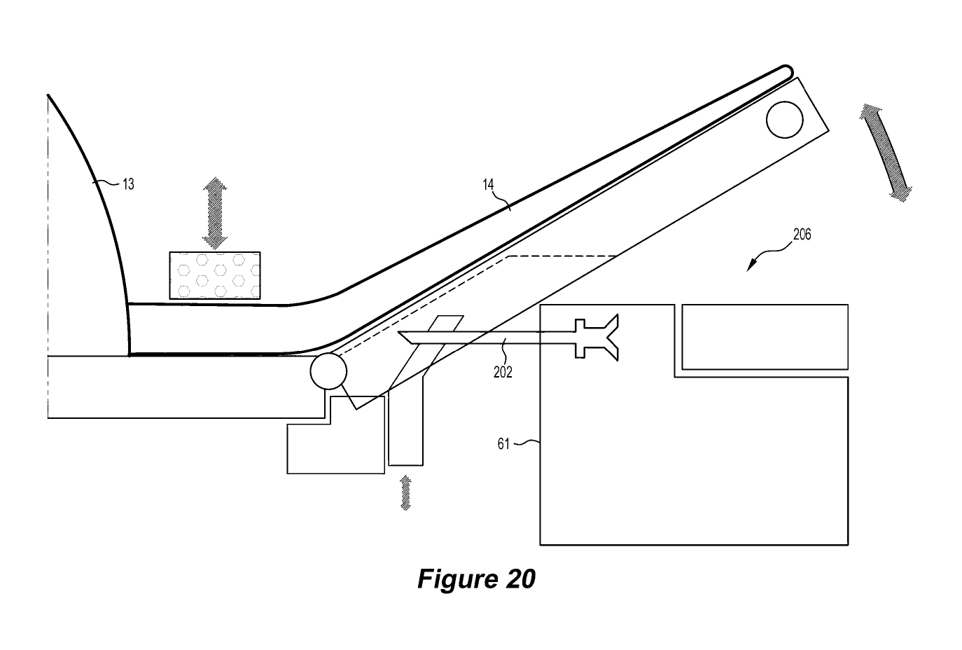

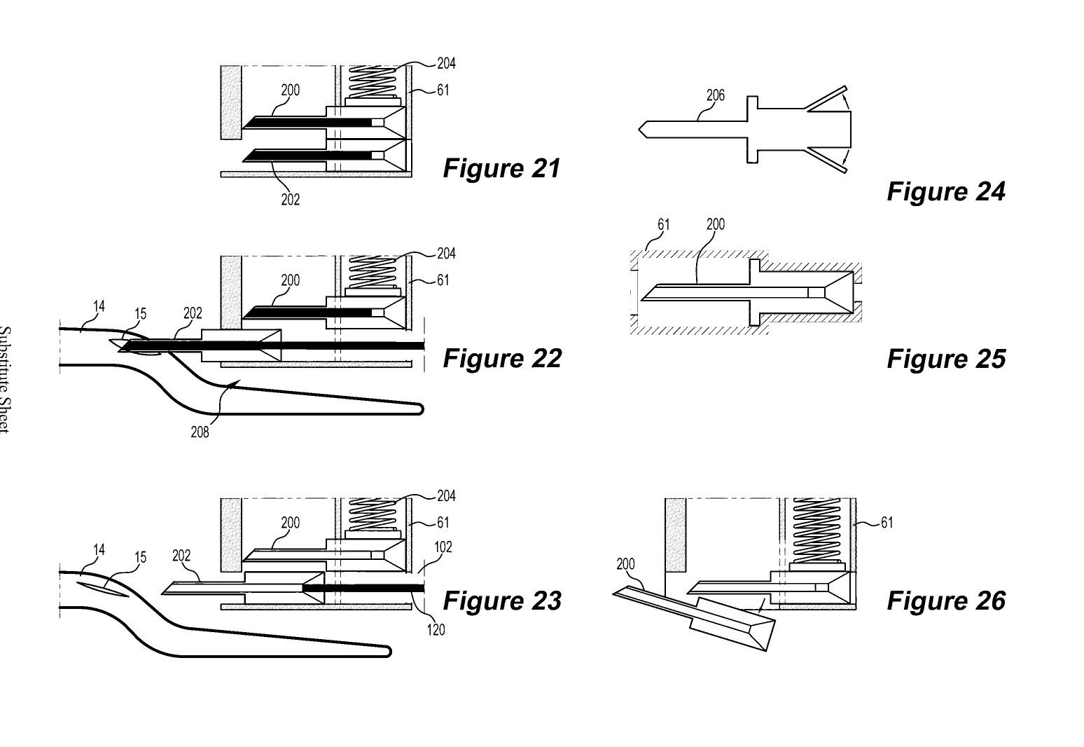

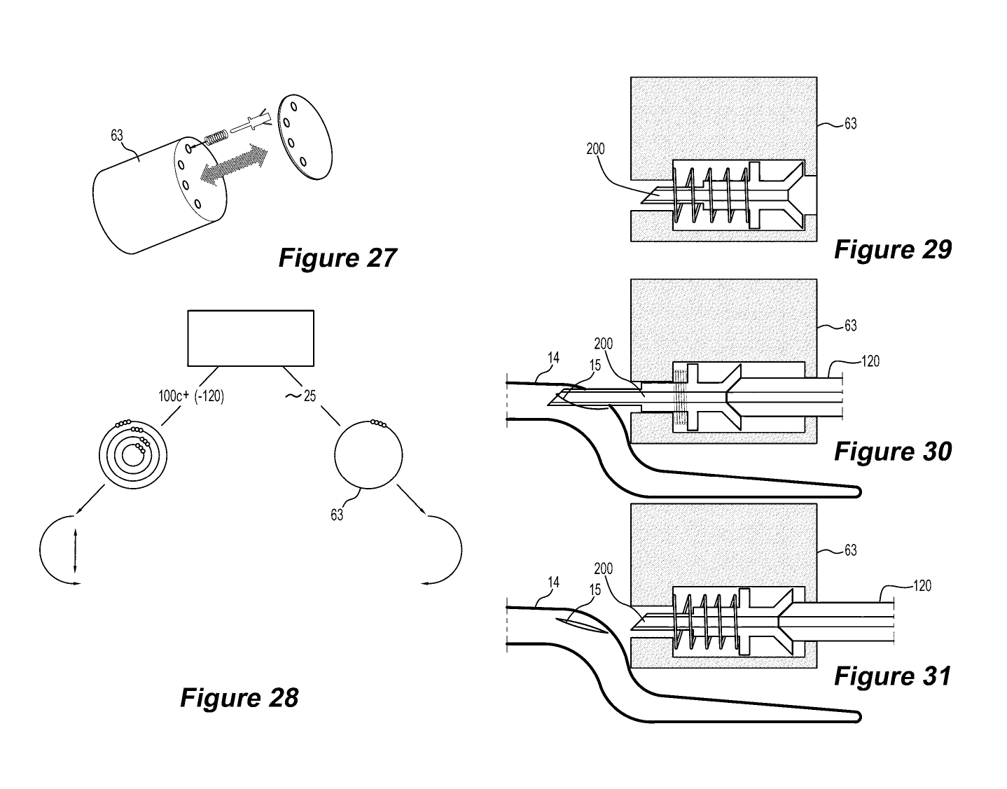

FIGS. 18 to 26 show schematic diagrams of another embodiment of a tag magazine 61 in which a plurality of cannulas are stacked.
The tag magazine 61 may contain a single column or a plurality of columns of a plurality of cannula 200, 202 each with at least one tag loaded in each cannula 200,202 at its proximal end that are fed by a spring 204 into an injector head 206 from the tag magazine 61. When the magazine 61 is inserted the bottom cannula 202 aligns with the plunger 102 of the injection head 206. The plunger 102 actuates the cannula 202 through an opening 206 in the magazine 61, injecting the RFID tag. The plunger 120 then retracts completely from the cannula 202. The cannula 202 is ejected from the bottom of the magazine 61 into a waste bin, and a new cannula 200 is fed into its place.
FIGS. 27 to 31 show schematic diagrams of another embodiment of a tag magazine 63. The cylindrical tag magazine 63 contains a single ring around the perimeter of the cylinder or a plurality of rings concentrically arranged from the perimeter of the cylinder inwards, of a plurality of cannula 200 each with at least one RFID tag loaded in each cannula at its proximal end that are spring fed into the injector head from the tag magazine 63. When the magazine 63 is inserted it is indexed to align a cannula with the plunger 120 of the injector head. Each cannula sits inside a spring loaded cell; after plunging for injection the cannula automatically retracts back inside its cell. The magazine 63 is rotated and the next cannula is plunged. Once the magazine 63 is spent, it is removed, including the used cannula inside it, and disposed of.

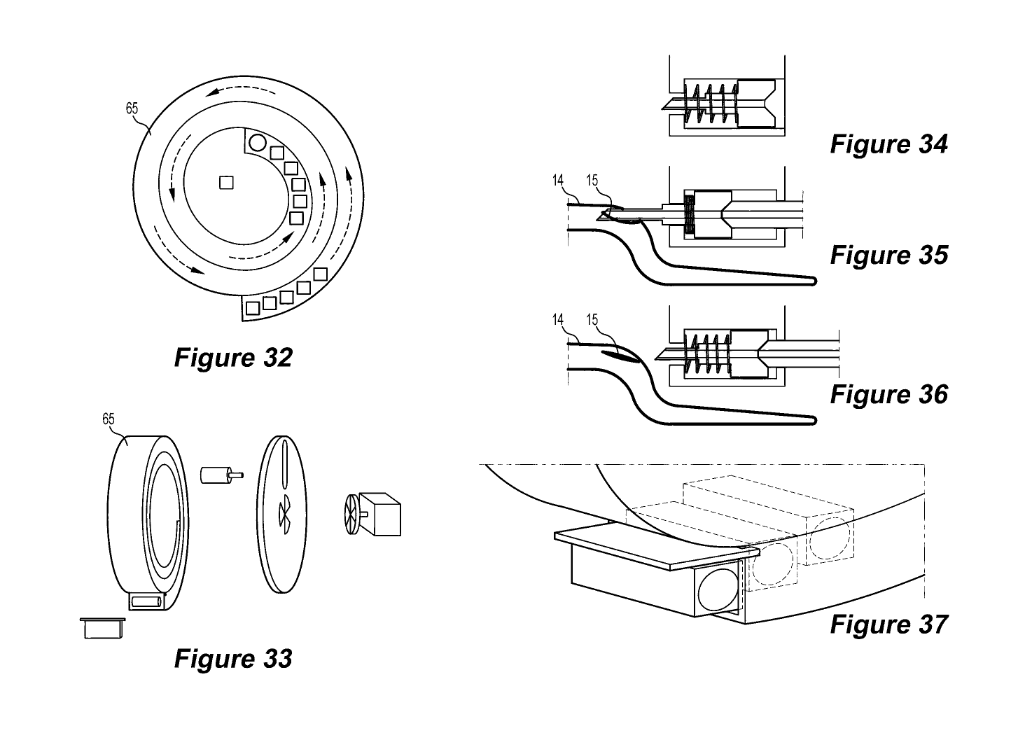

FIGS. 32 and 37 show schematic diagrams of another embodiment of a tag magazine 65.
The tag magazine 65 may comprise drum of a spiral of cannula seated inside a cylindrical cartridge. The drum sits above or below the injector head and feeds downwards into it or feeds upwards into it. When inserted, the magazine 65 sits flush and concentric with a driven spinning cam disk. A drive pin sits in a radial slot in the spinning cam disk, which extends into the drum magazine 65 to sit behind the last (innermost) cannula. The magazine 65 remains stationary while the cam disk rotates, which drags the drive pin through the spiral of the magazine 65, pushing the stack of cannula around the spiral and out the opening into the injector head. The cannula is then plunged and ejected into a waste bin or plunged and ejected into the catchment portion of the cartridge.

An embodiment of a method of operating an injection mechanism 206 may comprise at least some of the following steps:
A rodent is disposed on top of an angled tail restraint, 110, creating a bend in the tail
Sensors, which may be optical, capacitive, mechanical or other similar methods, detect the location of the surface of the tail.
A guide foot, like the foot on a sewing machine, is abutted against the top of the tail.
The cannula or tattooing needle passes through, and is directed by an aperture in the guide foot.
By moving the guide foot slightly up or down, the angle of the needle can be changed to accommodate different skin thicknesses.

In this embodiment of 21, the following operation may be enabled:
1. Drive injector head system down.
2. Skin sensor detects tail (injector head stops).
3. Guide foot drives forward to engage tail (spring compliance).
4. Guide foot lowers for fine needle control (fine control for the cannula is dependent on only small skin thickness adjustments).
5. Plunger system injects tag and retracts.
6. Guide foot raises to start position and retracts.
7. Injector head system raises to home.

In another embodiment of 20 the injection mechanism, 22, operates as follows:
The tail is disposed on top of an angled tail restraint, 110, creating a bend in the tail.
The paddle has a pocket in it in order to minimize the needle length.
The needle or cannula passes through, and is directed by, an aperture in the guide foot.
The needle or cannula enters parallel to the surface of the tail along the ramp.
By slightly moving the guide foot on an angle perpendicular to the tail, the angle of the needle can be changed to accommodate different skin thicknesses.

In this embodiment of 22, the following operation is enabled:
1. The animal restraint paddle, 96, 99, 100, is inserted until hardstop.
2. Guide foot driver raises needle into fine adjustment position (fine control for the cannula is dependent on only small skin thickness adjustments).
3. Plunger system injects tag and retracts (plunger system would need a solenoid or other drive mechanism that self-returns during power failure. This is because the angle of the needle of this concept is not parallel to the paddle 96, 99, 100).
4. Guide foot lowers to start position.
5. Paddle 96, 99 or 100 is removed.

In another embodiment of 20 the injection mechanism, 23, operates as follows:
Tail is inserted under soft foam roller by operator
Insertion of the paddle 96, 99, 100 into the tunnel 90,92 will cause the end half of the paddle to pivot about a lateral hinge, creating a bend in the tail
The cannula or needle passes through, and is directed by, an aperture in the guide foot
The guide foot moves slightly up or down accommodates different skin thicknesses

In this embodiment, the RFID tag is injected into the bottom side of the tail and the following operation is enabled:
1. Technician inserts paddle 96, 99, 100 into garage tunnel 90,92.
2. Paddle 96, 99 or 100 cam followers guided into lifted position
3. Paddle 96, 99, 100 stopped by hardstop
4. Pressure pad pushes tail into paddle (can be mechanically actuated by paddle)
5. Guide foot raises into fine adjustment position (fine control for the cannula is dependent on only small skin thickness adjustments)
6. Plunger system inserts needle, injects tag, and retracts
7. Guide foot lowers to a starting position
8. Pressure pad lifts (can be actuated by paddle)
9. Paddle 96, 99, 100 is removed and returns to horizontal configuration

In one embodiment of 21, 22 and 23, the injection mechanism is operated by a processor. In another embodiment of 21, 22 and 23 the injection mechanism is operated by a technician manually, for example by using the user interface 114.

RFID Tag

The RFID tag 15 is in the form of a RFID tag comprising an antenna. The RFID tag 15 has a length of 4 mm, width 0.5 mm and a height of 0.2 mm. The radio device comprises an assembly comprising a RFID device 130 in the form of an IMPINJ MONZA RP-6 RFID integrated circuit. The assembly has a dipole antenna 132 comprising 2 parts that are each 2 mm long strips of copper that are gold plated. The assembly comprises an antenna substrate in the form of a sheet of KAPTON 134. The assembly is encapsulated in parylene, the encapsulating layer of parylene having a thickness of 2-5 μm. In an alternative embodiment, the RFID tag is a SAW RFID tag. Generally, any suitable RFID tag may be used.

The RFID device 130 has read and write capabilities and a memory to store data, operating in the Ultra High Frequency (UHF) band for example, in the range of 860 MHz to 920 MHz to ISO 18000-6 and EPC Gen 2 standards), configured to work within the regulated power maximum of 4 watts EIRP for the USA and other countries that operate to this standard and 2 watts ERP for the European Union. The electromagnetic wave that provides power to the RFID tag 14 is in this but not necessarily in all embodiments a RFID an interrogation radio wave from a RFID reader, for example. The RFID tag 15 responds to receiving the RFID interrogation radio wave, by the RFID device 130 of the RFID tag 15 generating an identification radio signal carrying information in the form of identification information which is transmitted as the identification radio wave. The radio signal is generated according to an air interface protocol which may be any suitable air interface protocol, for example RAIN RFID, and EPC global UHF Class 1 Gen2/ISO 18000-63 (formerly 18000-6C).

The identification information may be unique, or at least unique for a group of animals. However, the identification information may not be unique, but rather identify some other feature of the animal, for example the sex and genetic characteristic. Generally, but not necessarily, the identification information comprises a code in the form of an Electronic Product Code (EPC) is stored in the RFID tag's memory. The code is written to the RFID tag 15 by a RFID reader, and which may take the form of, for example, a 96-bit string of data. Alternative embodiments may not store an EPC. The first eight bits may be a header which identifies the version of the air interface protocol. The next 28 bits may identify the organization that manages the data for this tag. The organization number may be assigned by the EPC global consortium. The EPC or part thereof may be used as a key or index number to uniquely identify that particular animal represented in a data store in the form of an electronic database. In this embodiment, stored in RFID tag user memory is an object class, identifying the kind of animal the tag is attached to (e.g. “mouse” or “rat”), and a unique number for a particular tag encoded as follows:
Position 1=Gender
   0=Male
   1=Female
Positions 2-9
   Enclosure identification (2 numeric digits—00 to 99 which addresses 8 bits, 2-5 for the first digit 0-9 and positions 6-9 for the second digit 0-9)
Positions 10-18
   Strain code (00-9Z)
Positions 19-26
   Protocol identification—a two digit numeric code

The RFID tag 15 is responsive to an interrogating radio wave in the ultra-high frequency (UHF) band, in this but not all embodiments.

RFID Reader

The RFID readers comprises a RFID antennae and a RFID receiver is signal communication with the antennae. Electrically conductive pathways in the form of cables wires and/or traces for example, may electrically connect the RFID antennae and the RFID receiver. The cables are in this embodiment co-axial cables for radio frequencies, for example UHF, received and/or transmitted by the RFID tag 15. The RFID reader receiver comprises an amplifier that amplifies the RFID tag radio signal received via the antennae. The receiver comprises a demodulator that compares the modulated signal to a signal generated by an oscillator of the same carrier frequency, thereby extracting a message from the radio signal.

A RFID reader controller in the form of a digital signal processor is configured to process the message extracted from the signal to obtain the animal identification information. The RFID reader controller sends the animal identification information. The RFID reader controller generally controls communications with middleware and backend systems, runs the primary operation systems for the RFID reader, and controls memory usage.

A code in the form of an Electronic Product Code (EPC) may be stored in the RFID tag's memory, written to the RFID tag 15 by the RFID reader

The RFID reader may send a string of symbols after derived from an interrogation comprising, for example, the code, last seen time for the tag 14, last seen date for the tag 14, first seen time for the tag 14, first seen date for the tag 14, received signal strength indicator (RSSI), Protocol control (PC) and a cyclic redundancy check (CRC).

In the present embodiments, but not all embodiments, when the antenna is activated beneath one the RFID tagged animal 13, the antenna will capture and transmit to the reader:
The date and time the antenna activated
A unique identification
The RFID tag EPC codes it read (one or more animal tag codes and the enclosure tag EPC code)
All data in the User Memory portion of the read RFID tags.

The RFID reader 20 comprises a RFID interrogation signal transmitter configured to transmit an RFID interrogation signal via the RFID antennae. The RFID interrogation signal uses an air interface protocol which may be any suitable air interface protocol. The RFID interrogation signal transmitter may comprise a base band transmitter to generate the interrogation signal, a power amplifier to amplify the signal produced by the oscillator and a modulator to modulate the amplitude, frequency or phase of the oscillator's frequency. While the RFID reader is monostatic, other embodiments may be bistatic (that is separate antenna for transmitting the interrogation signal and receiving the radio signal 22) or multistatic, for example.

The RFID reader 20 may comprise a RFID reader processor, for example, at least one of a digital signal processor, and an application specific integrated circuit (ASIC) incorporating signal processing functions described above. In the present embodiment, however, the RFID reader comprises a host logic device and at least one RFID reader chip in the form of an IMPINJ INDY RS2000 reader chip. When using the IMPINJ INDY RS2000 reader chip, a MONZA R6-P RAIN RFID tag chip, for example, may be attached to the animal, however generally any suitable RFID tags may be used. The host is in communication with the reader chip via a UART serial interface or generally any suitable interface. The host comprises a RASBERRY PI, supporting 10/100 Ethernet, and 2.4 GHz 802.11n wireless, BLUETOOTH 4.1 CLASSIC and BLUETOOTH LOW ENERGY, and USB 2.0. Communication with the processor may be with any of these protocols. Any suitable host may be used, including QUALCOMM Dragonboard 410c, system-on-a-board and microcontrollers, an example of which is the MSP430 IRI-LT host microcontroller. The RFID reader processor sends the read identification information in a datagram having the identification information as a payload, via a USB interface or alternatively via the Ethernet interface, or generally any suitable communications interface is provided.

The reader 20 comprises a printed circuit board assembly (PCBA) comprising the host logic device, RFID reader chip, and firmware. Traces on the PCB electrically connect the host and chip. A user interface for the reader 20 may be presented on a smart phone or tablet computer, for example.

The RFID reader may comprise a housing suitable for supporting the scales, for example a steal, or hard polymer case.

Processor

The controller comprises a processor in the form of system-on-a-board (in these embodiments, QUALCOMM Dragonboard 410c) in communication with the user interface 114 and in communication with the systems 20,30 via USB or other communications protocol, or alternatively an embedded system, or generally any suitable device. The processor 32 may be a computer server, for example a computer server in communication with the controller 40 via a computer network in the form of any one of a LAN, WAN, Ethernet network, a Wi-Fi network, or a cellular network or internetwork, for example the internet. The processor has a network interface comprising a physical layer network interface, for example a RJ45, BNC, USB, FIREWIRE, or THUNDERBOLT network connector or generally any suitable type of connector. The processor 32 may be a virtual machine or cloud virtual server in the form of an AZURE, AMAZON or another server. The cloud virtual server may have a N tier architecture, in which presentation, application processing, and data management functions may be physically separated. It has a service orientated modular architecture. The cloud virtual server architecture provides infrastructure services (hosting, DR, storage, CPU, RAM, Firewalls etc.). Azure internet of things hub may manage connectivity to each system 10, 20, 30, 40.

The processor 32 has non-transitory processor readable tangible media in the form of non-volatile memory (for example FLASH memory or a hard drive). Stored in the memory is a software application that comprises program instructions that when executed by the processor cause the processor to perform a method disclosed above.

Now that embodiments have been described, it will be appreciated that some embodiments have some of the following advantages:
The mark and the attached RFID tag may be permanent, and thus the animal has permanent identification attached.
The RFID tag may be implanted within the animal, and not be external of the animal, which may prevent removal of the RFID tag.
The mark and the attached RFID tag may be attached to a living animal (i.e. in vivo).
Manual labour may be reduce, saving time and money.
Marking may be reduced, saving time and money.

Variations and/or modifications may be made to the embodiments described without departing from the spirit or ambit of the invention. For example, the marking may not be a tattoo, but a print or label. The present embodiments are, therefore, to be considered in all respects as illustrative and not restrictive. Reference to a feature disclosed herein does not mean that all embodiments must include the feature.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1-59. (canceled)

60. A system for attaching a radio frequency identification (RFID) tag to an animal when received thereby, the system being configured for mounting thereto a RFID tag magazine comprising a plurality of cannulas that each contain at least one RFID tag, wherein the RFID tag magazine is configured for presentation of any one of the plurality of cannulas to the animal when so received.

61. The system defined by claim 60 configured for rotationally mounting thereto the tag magazine.

62. The system defined by claim 60 wherein RFID tag magazine comprises a fluted rotor having a plurality of flutes in which the plurality of cannulas are received for sliding presentation of any one of the plurality of cannulas to the animal when so received.

63. The system defined by claim 62 wherein the system comprises a cannula actuator engagable with a selected cannula of the plurality of cannulas, and when so engaged with the selected cannula, slidingly present the selected cannula to the animal when so received.

64. The system defined by claim 60 wherein the system comprises:
a cannula actuator engagable with a selected cannula of the plurality of cannulas, and when so engaged with the selected cannula, slidingly present the selected cannula to the animal when so received;
a plunger movable within any one of the plurality of cannulas for positioning the RFID.

65. A RFID tag magazine for a system for attaching a RFID tag to an animal when received thereby defined by claim 60, the RFID tag magazine comprising a plurality of cannulas that each contain at least one RFID tag wherein the magazine is configured for presentation of any one of the plurality of cannulas to the animal when so received.

66. The RFID tag magazine defined by claim 65 wherein the plurality of cannulas each comprise a plurality of RFID tags.

67. The RFID tag magazine defined by claim 65 wherein the plurality of cannulas each comprise a single RFID tag.

68. The RFID tag magazine defined by claim 65 wherein the tag magazine is configured for rotational mounting within the system.

69. The RFID tag magazine defined by claim 65 configured for rotationally mounting the system for attaching a RFID tag to the animal when received thereby.

70. The RFID tag magazine defined by claim 65 comprising a fluted rotor having a plurality of flutes in which the plurality of cannulas are received for sliding presentation of any one of the plurality of cannulas to the animal when so received.

71. A system for attaching identification information to an animal, the system comprising a system for attaching a RFID tag to the animal defined by claim 1, a system for marking an animal, and a controller for controlling the system for attaching the RFID tag and the system for marking the animal.

72. The system defined by claim 71 wherein the system for marking the animal is configured for mounting thereto a tattooing needle magazine comprising a plurality of tattoo needles, wherein the tattoo needle magazine is configured for presenting any one of the plurality of tattoo needles to the animal when so received.

73. The system defined by claim 71 configured for receiving at least one further system for attaching a RFID tag and at least one further system for marking an animal.

74. The system defined by claim 71 wherein the mark is human readable.

75. The system defined by claim 71 wherein the system for attaching a RFID tag to the animal comprises an RFID attachment module, and the system for marking the animal comprises an animal marking module, and the controller comprises a control module.

76. The system defined by claim 75 wherein the RFID attachment module, the animal marking module and the control module are fastened together.

77. The system defined by claim 71 wherein the controller causes magazine rotor of the RFID tag to rotate after the presented cannula has been empties of RFID tags, and present another cannula having at least one RFID tag.

78. The system defined by claim 71 wherein the controller is in communication with a computing device, and the controller is configured to send identification information attached to the animal to the computing device for storage in a datastore.

79. The system defined by claim 71 comprising a plurality of motors operationally coupled to at least some of the RFID tag magazine, the carousel, the plunger and the cannula actuator.
